(19) United States
(12) Patent Application Publication
(10) Pub. No.: US 2022/0171772 A1
(43) Pub. Date: Jun. 2, 2022

(54) STRUCTURED QUERY LANGUAGE INTERFACE FOR TABULAR ABSTRACTION OF STRUCTURED AND UNSTRUCTURED DATA

(71) Applicant: Garner Distributed Workflow Inc., Toronto (CA)

(72) Inventors: Attila Vanderploeg, TORONTO (CA); Vlad Mandrychenko, TORONTO (CA)

(21) Appl. No.: 17/672,231

(22) Filed: Feb. 15, 2022

(51) Int. Cl. G06F 16/242; G06F 16/2453

(52) U.S. Cl. CPC G06F 16/2448; G06F 16/24547; G06F 16/24532

(57) ABSTRACT

The subject matter discloses a system for handling complex database queries using parallel HTTP requests. The system includes a processor configured to receive a query from a software application to access relational data from a data source. The system processes the received query to generate a plurality of queries that are delivered concurrently as HTTP requests to API Backends to retrieve data. For each request to each of the API Backends, Cypher request is sent to the data source. A plurality of GraphQL responses are received from the backends. The system further generates a table from the responses based on a relational database schema such as user-defined table functions (UDTFs) and transmits the generated table to the nodes as a response to the database query.

### CROSS-REFERENCES TO RELATED APPLICATION

None.

### FIELD OF THE INVENTION

The disclosure generally relates to data mining and web technology, and in particular to a system and method of handling complex database queries using parallel HTTP requests.

### BACKGROUND

Advancements in data mining and web technology have led to development of various software applications and web services that connect to Web Application Programming Interface (APIs) to query data from various types of data sources for reporting and other purposes. For example, an interactive data visualization software can connect to Web APIs to query data for reporting on client-side interface and for visualization purpose. In some instances, the software may not be able to connect to a Web API for database queries directly as there may no existing connectors that would allow connecting to the API. In some other instances, the Web API may generate response (that includes the data) in a schema that is unsupported by the software. In case of complex queries, the Web API may not be able to handle bulk of the data due to memory constraints. All of such issues may limit the type of information the software application can handle and may also limit delivery of services (e.g., data visualization) that depend on responses of such a Web API.

Limitations and disadvantages of conventional and traditional approaches will become apparent to one of skill in the art, through comparison of described systems with some aspects of the present disclosure, as set forth in the remainder of the present application and with reference to the drawings.

### SUMMARY OF THE INVENTION

The subject matter discloses a system and method of handling complex database queries using parallel HTTP requests. The system includes a processor configured to receive from a software application executable on one or more nodes, a database query that corresponds to a request to access relational data from a data source. The received database query is processed to generate a plurality of queries, each of which includes data with a syntax that is in accordance with a query language different from that of the database query. In various aspects, a plurality of HTTP requests is delivered concurrently to an API backend. For each of the requests received at the backend, a cypher request is sent to the data source to retrieve data. A plurality of responses is received from the backend, in a response to the delivery of the plurality of HTTP requests, wherein each response of the received plurality of responses includes a portion of data of the data source in a format that is different from a schema of the data source. For example, the response can be in a non-relational database format (such as JSON (JavaScript Object Notation) or eXtended Markup language (XML)) format that is different from a relational database schema of the data source. The system generates based on the plurality of responses from the backend, a table that is defined by a one or more User Defined Table Functions (UDTFs) and transmits the generated table to the one or more nodes as a response to the database query.

In various embodiments, the software application is an interactive data visualization software (such as Business Intelligence (BI) application). The database query is in the form of a Structured Query Language (SQL) query and the query language of each of the plurality of queries is a GraphQL® query language. In another embodiment, the database query is processed using a GraphQL® API, an HTTP API, or a combination thereof.

In various aspects, the processor is further configured to assign each query of the plurality of queries to a corresponding worker thread of a plurality of worker threads on the system. The plurality of HTTP requests is delivered concurrently based on the assignment. The processor in various embodiments, is further configured to receive authentication credentials from the software application, generates a plurality of authentication tokens based on the received authentication credentials, and passes each authentication token of the generated plurality of authentication tokens to the corresponding worker thread of the plurality of worker threads. The plurality of worker threads uses such authentication tokens to verify the authentication credentials with credentials of the GraphQL® API. The verification is performed before the delivery of the plurality of HTTP requests. In some embodiments, each authentication token of the plurality of authentication tokens is an Open Authorization (OAuth) token.

In some embodiments, the format in which the data is received from the data source corresponds to a non-relational database schema and is one of a JavaScript Object Notation (JSON), eXtended Markup Language (XML), or YAML. The processor is further configured to apply one or more user-defined table functions (UDTFs) on the received responses to generate a table with records. In some embodiments, the processor is configured to derive the relational database schema for the generated table, based on the plurality of responses that contain the data. In some embodiments, each response of the plurality of responses includes a portion of the data with a pagination.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

The disclosure has other advantages and features, which will be more readily apparent from the following detailed description of the invention and the appended claims, when taken in conjunction with the accompanying drawings, in which:

FIG. 1 is a diagram that illustrates a system for handling complex database queries using parallel HTTP requests, in accordance with an embodiment of the disclosure.

FIG. 2 is a diagram that illustrates token management in the Data Pull Diagram, in accordance with an embodiment of the disclosure.

FIG. 3 is a diagram that illustrates a Language Server Protocol (LSP) Push API, in accordance with an embodiment of the disclosure.

FIG. 4 is a flowchart of a method of handling complex database queries using parallel HTTP requests, in accordance with an embodiment of the disclosure.

FIG. 5 is a block diagram of the system of FIG. 1, in accordance with an embodiment of the disclosure.

FIG. 6 is a diagram that demonstrates the incorporation of the system and the method in a BI system.

Referring to the drawings, like numbers indicating parts throughout the views.

### DETAILED DESCRIPTION OF THE EMBODIMENTS

The subject matter discloses a system, a method, and a non-transitory computer-readable medium that is capable of abstracting a Web API (such as a GraphQL® API) as a query execution and data abstraction interface (such as a Spark® SQL interface) to achieve parallelism and compatibility with software, such as interactive data visualization software. This is achieved by distributing each database query (such an SQL query) into multiple parallel queries (such as GraphQL® queries) that may retrieve multiple pages of a table at a time from a data source. Such queries are executed concurrently by worker threads (e.g., Spark® Workers) through concurrent HTTP requests to one or more API backends. Thereafter, data (responses) that is received in response to the HTTP requests is processed using UDTFs and served as a single table to node(s) that include the software (e.g., a Business Intelligence (BI) application) and served the database query.

The disclosed subject matter supports distributed retrieval and parallelism. These speeds up the process of retrieving data from the data source. Hence an enormous amount of data may be retrieved in limited time. The prior art systems do not disclose parallelism and hence are time consuming. A report generation in prior art systems may take some minutes to hours depending on the volume of data retrieved. Also a custom authentication mechanism for OAuth2 based on API Abstraction interface username and password authentication is built into the protocol. This enables authentication to be performed at the backend with the user credentials received from the software. The subject matter also discloses receiving response from the data source that is represented as a table that may be retrieved and described via SQL describe command. This allows for automatic schema derivation in business analytics tools.

While the invention has been disclosed with reference to certain embodiments, it will be understood by those skilled in the art that various changes may be made and equivalents may be substituted without departing from the scope of the invention. In addition, modifications may be made to adapt to a particular situation or material to the teachings of the invention without departing from its scope.

Throughout the specification and claims, the following terms take the meanings explicitly associated herein unless the context clearly dictates otherwise. The meaning of “a”, “an”, and “the” include plural references. The meaning of “in” includes “in” and “on.” Referring to the drawings, as numbers indicate like parts throughout the views. Additionally, a reference to the singular includes a reference to the plural unless otherwise stated or inconsistent with the disclosure herein.

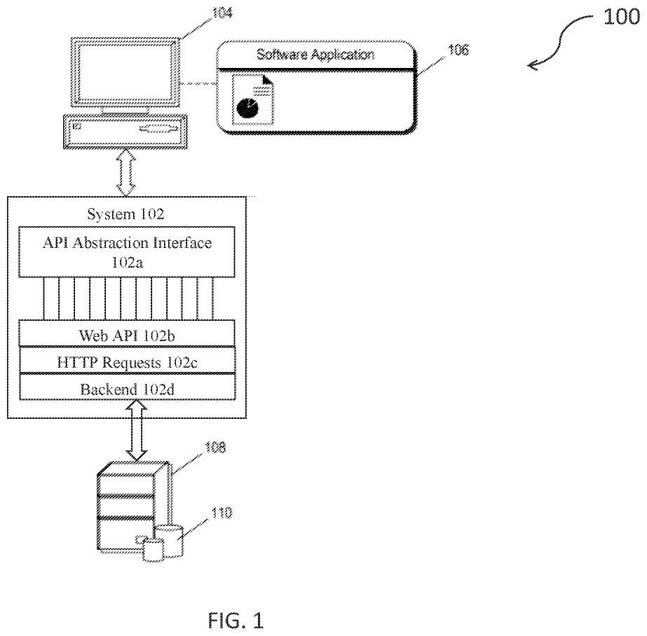

The present subject matter is further described with reference to FIG. 1-FIG. 5. It should be noted that the description and figures merely illustrate the principles of the present subject matter. It is thus understood that various arrangements may be devised that, although not explicitly described or shown herein, encompass the principles of the present subject matter. Moreover, all statements herein reciting principles, aspects, examples, and embodiments of the present subject matter, as well as specific examples thereof, are intended to encompass equivalents thereof.

FIG. 1 is a diagram that illustrates a network environment for handling complex database queries using parallel HTTP requests, in accordance with an embodiment of the disclosure. With reference to FIG. 1, there is shown a network diagram 100. The network diagram 100 includes a system 102, one or more nodes 104, software application 106, one or more servers 108, and a data source 110. The system 102 is communicatively coupled to the nodes 104. The system includes an API Abstraction Interface 102a, a Web API 102b, Hyper Text Transfer and Protocol (HTTP) requests 102c and a backend 102d. The system 102 includes a group of elements that include a processor, a memory, an I/O interface, and a network interface that work together to accomplish one or more tasks. Nodes 104 are electronic devices that are attached to a network and are capable of creating, receiving or transmitting information over a network. The one or more servers 108 are network computers dedicated for data source storage. The data source 110 represents enormous amount of structured data or un-structured data or both. The backend 102d in the system 102 connects to the data source 110 to retrieve data for the requests.

The system 102 as shown in FIG. 1 includes a processor that is configured to receive from the software application 106 executable on one or more nodes 104, a database query that corresponds to a request to access relational data from a data source 110. In various embodiments, the software application 106 is a Business Intelligence (BI) application including, but not limited to BI applications, Power BI®, Tableau® and the like. The received database query is processed in the system at the API Abstraction Interface 102a to generate a plurality of queries each of which includes data with a syntax that is in accordance with a query language different from that of the database query.

In one embodiment the database query is a Structured Query Language (SQL) query or Spark SQL® query. Spark SQL® is a Spark module for structured data processing. The Spark SQL® interface provides Spark with additional information about the structure of the data, Spark SQL uses this additional information to perform optimizations. In another embodiment, the query language of each of the plurality of queries is a GraphQL® query language. The GraphQL® query language gets the data needed by an application in a single request, hence speeding up the process and reducing the processing time. The database query is processed using a GraphQL® API or an HTTP API or both.

In various aspects based on the plurality of queries generated in the API Abstraction Interface 102a, a plurality of HTTP requests 102c are delivered concurrently to one or more backends 102d. In various aspects the processor is further configured to assign each query of the plurality of queries, to a corresponding worker thread of a plurality of worker threads on the system. In various embodiments, the plurality of HTTP requests 102c are delivered concurrently based on the assignment. In various embodiments, the processor is further configured to receive authentication credentials from the software application 106. A plurality of authentication tokens are generated based on the received authentication credentials and each authentication token of the generated plurality of authentication tokens is passed on to the corresponding worker thread of the plurality of worker threads.

In various aspects, for each of the HTTP GraphQL requests received at the backend, a cypher request is sent to the data source 110 to retrieve required data from the data source 110. In various embodiments, a plurality of responses is received from the backend 102d, in a response to the delivery of the plurality of HTTP requests to the backend. Each response of the received plurality of responses includes a portion of data of the data source 110 in a format that is different from a schema of the data source. In various aspects, the system generates a table that is defined by one or more user-defined table functions (UDTFs) and transmits the generated table to the one or more nodes as a response to the database query. In various embodiments, the processor is further configured to apply the UDTFs on the plurality of responses from the backend to generate the table with records.

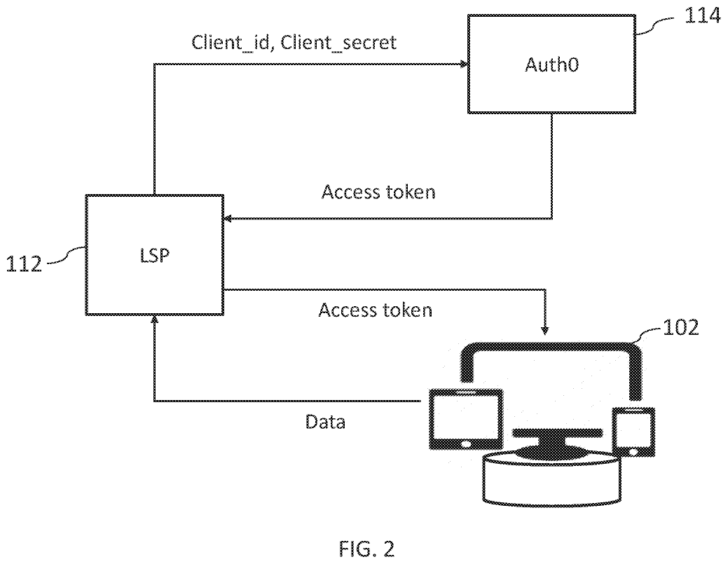

FIG. 2 is a diagram that illustrates the token management in the Data Pull Diagram, in accordance with an embodiment of the disclosure. With reference to FIG. 2, there is shown a token management system. The token management includes a Language Server Protocol (LSP), an Open Authorization (OAuth) token system and the system 102 receiving tokens for authentication. A LSP is an entity that offers services related to languages. OAuth is an access token used by the application to make API request on behalf of a user and represents the authorization of an application to access specific parts of a user's data.

In various embodiments, the plurality of worker threads uses the plurality of authentication tokens 114 to verify the authentication credentials with credentials of the Web API (such as a GraphQL® API) 102b. In various embodiments, the verification is performed before the delivery of the plurality of HTTP requests from 102c. In various embodiments, each authentication token of the plurality of authentication tokens is an OAuth token. The system enables OAuth token propagation to Spark workers to allow for OAuth2 authentication with the Web API (such as a GraphQL® API). OAuth2 is the industry-standard protocol for authorization. In various embodiments, Spark® is customized to send the authentication credentials from the software application 106 to the Spark authenticator which makes a call to Auth0 and passes the token to the backend that makes the parallel calls. In various embodiments, in order to obtain tokens from Auth0 to access the Web API (such as a GraphQL® API) the system generates a post to Auth0 Uniform Resource Locator (URL) to obtain access and refresh tokens. The post to URL includes one or more fields including, but not limited to fields, TENANT_NAME, CLIENT_ID, CLIENT_SECRET or the like. The response from the URL includes the token. The response may include fields including but not limited to ACCESS_TOKEN, TOKEN_TYPE, EXPIRES_IN and the like.

In various embodiments, the tokens are used to access the API. The system generates a post to the API that includes a header and named authorization, with the value being the token. In various embodiments, the tokens are reused for the API calls until the token expires, at which point the token may be refreshed again through Auth0. For example, if the ACCESS_TOKEN expiry is configured to be 1 hour, then there are only 24 calls per day to obtain the access_token using CLIENT_SECRET. The benefit of reusing the access_token is the fact that it provides temporary throwaway access and when obtained by intruders, the token becomes useless after its expiry. The field CLIENT_SECRET is only used a limited number of times for the purpose of obtaining the temporary access token, thus minimizing the chance of exposure to intruders over the wire.

The token management system sets up a client id for the LSP 112 system. A client secret token is generated by Auth0 and transmitted manually to LSP 112. In one embodiment the token is long-lived. In another embodiment, the access token is short-lived. The access token is signed with Auth0's private key and is validated using Auth0's public key. When the access token expires, an Expired Token Response is generated the next time it is used. LSP 112 may then use the Client ID and Client Secret to request a new Access from Auth0

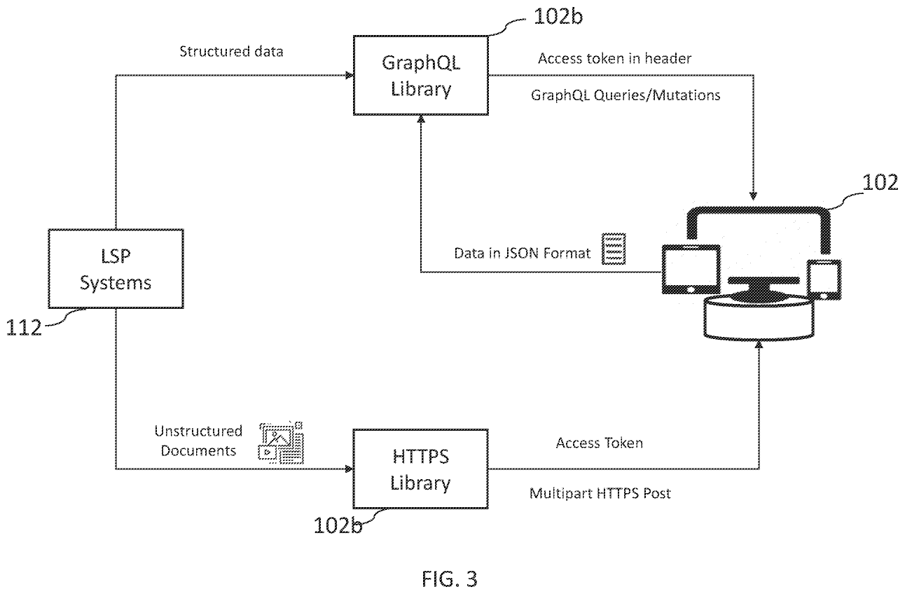

FIG. 3 is a diagram that illustrates a LSP Push API, in accordance with an embodiment of the disclosure. With reference to FIG. 3, an LSP Push API is disclosed. The LSP Push system sends structured and unstructured data from the LSP 112 to the system 102. The structured data are sent to the Web API library (such as a GraphQL® library) 102b and the unstructured data are sent to the HTTPS Library 102b. GraphQL® uses a temporary secret access token in the header and multiple small calls to the API are made. The unstructured data include data but not limited to, PDF documents, photos, and the like. The unstructured data is uploaded through Representational State Transfer (RESTful) API, with an access token in the header. A RESTful API is an application programming interface that conforms to the constraints of REST architectural style and allows for interaction with RESTful web services.

In some embodiments, the format corresponds to a non-relational database schema and is one of a JavaScript Object Notation (JSON), eXtended Markup Language (XML), or YAML. GraphQL® is JSON over HTTP. In various embodiments, if access tokens are invalid or if there is a system issue, then an HTTP error is returned. For data issues, e.g. invalid ids or data formats, the system returns GraphQL® errors. In various embodiments, error handling is done by the LSP integration program in the LSP system. GraphQL® is JSON over HTTP. In the HTTP perspective to make GraphQL® calls from HTTP the system needs POST (recommended) or GET to URL, headers and Body (POST) or GET with query HTTP parameter and URL encoded JSON as its value. JSON Fields are operationName, variables (a JSON Object) and query—a string that encapsulates the GraphQL® query itself.

In various embodiments, each response of the plurality of responses includes the portion of data with pagination. In various embodiments, the API includes a predetermined default page size that may change from time to time. If the pagination requirements are not provided in the request, the default number rows are received with additional info that allows retrieving the next page and the page after and so on. In various embodiments, the offset is calculated based on the page size that is received in the response. In various embodiments, the page size is controlled by providing one or more parameters as part of a filter set. Pagination may also be performed over the result set. The page object in the response contains information to paginate over the entire dataset in the database. The field “limit” includes the page size, except for the last page. “offset” is another field that includes the starting point in the entire dataset, “offset with limit” represents a slice of data. The field “hasNextPage” indicates the presence of additional results. In various embodiments, the program may rely on “hasNextPage” to continue looping by re-setting offset until “hasNextPage” becomes false. To prevent memory overflow “absolute maximum page size” is set. For a greater page limit than what is allowed, the maximum number of rows allowed is received and no error is thrown. In various embodiments, “absolute maximum page size” may change from time to time.

In various embodiments, with UDTF, the system 102 is configured to run a transformation on a basic hardcoded seed table with 1 column and 1 row and transform that row into a fully populated table with data from the Web API (such as a GraphQL® API). The transformation includes calling the Web API (such as a GraphQL® API) for every query received from the BI tools, retrieving the data from the data source via the backend, transforming graph structure into the tabular structure and creating the necessary number of columns in the table. In various embodiments, to speed up the process of populating the table parallelism was used in which multiple parallel HTTP requests were made to get the pages of the data at the same time and merge the data. In an exemplary embodiment, a ZIO toolset is used and ZIO based library of services are developed to make API calls in parallel that is used in the UDTFs. ZIO is a zero-dependency Scala library for asynchronous and concurrent programming. In various embodiments, the system includes a module that allows for the definition of the columns that are automatically translated into the actual Spark SQL columns with the data retrieval. This is achieved by grouping the different types of columns and reusing the data retrieval logic for them.

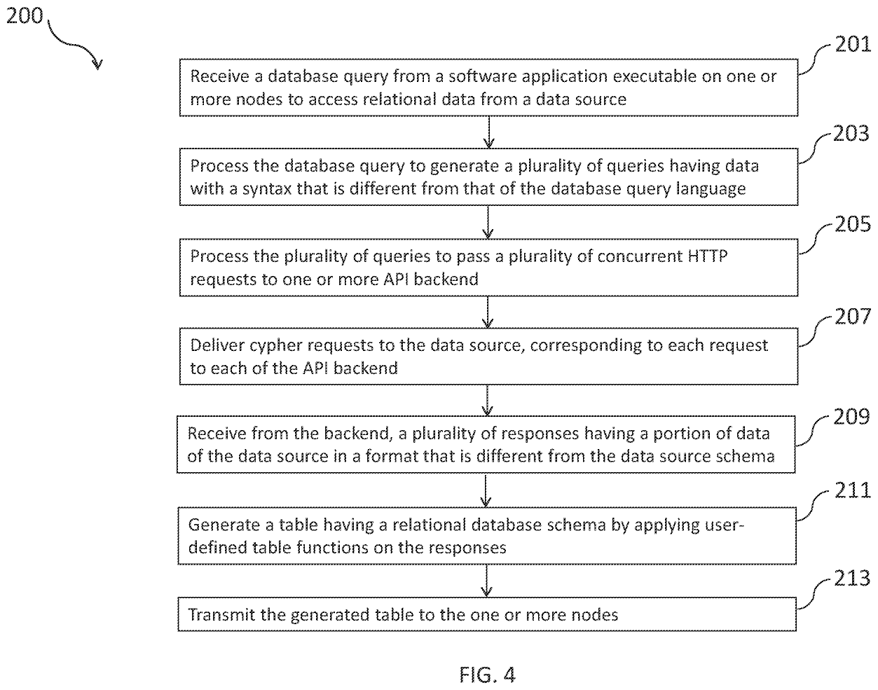

FIG. 4 is a flowchart that illustrates the method of abstracting GraphQL® API as a Spark SQL® interface. In various embodiments, the subject matter is a method of abstracting a Web API (such as a GraphQL® API) as an API Abstraction interface (such as a Spark® SQL interface). Method 200 as illustrated in FIG. 4 includes receiving, from a software application a database query that requests to access relational data from a data source. The query is executable on one or more nodes. In various embodiments, the database query is a SQL query or Spark SQL®. In various embodiments, the query language of each of the plurality of queries is GraphQL®. The received database query is processed in block 203 to generate a plurality of queries. In various embodiments, each query includes data with a syntax that is in accordance with a query language different from that of the database query. In various embodiments, the plurality of queries are processed in block 205 to pass a plurality of concurrent HTTP requests to one or more API backends. In various embodiments, the database query is processed using the GraphQL® API or an HTTP API or both.

In various embodiments, the method further includes assigning each query of the plurality of queries to a corresponding worker thread of a plurality of worker threads on the system, wherein the plurality of HTTP requests are delivered concurrently based on the assignment. The method further includes receiving authentication credentials from the software application, generating a plurality of authentication tokens based on the received authentication credentials. The method then involves passing each authentication token of the generated plurality of authentication tokens to the corresponding worker thread of the plurality of worker threads. In various embodiments, the plurality of worker threads uses the plurality of authentication tokens to verify the authentication credentials with credentials of the Web API (such as a GraphQL® API). In various embodiments, the verification is performed before the delivery of the plurality of HTTP requests.

The method further in block 207 includes delivering cypher requests to the data source. For each request received at the API backend, a cypher request is sent to the data source to retrieve data. In block 209, a plurality of responses are received from the backend, in response to the plurality of HTTP requests. In various embodiments, each response of the received plurality of responses includes a portion of data of the data source in a format that is different from a schema of the data source. In various embodiments, the plurality of responses are processed to generate a table in block 211 that is defined by one or more UDTFs and the generated table is transmitted in block 213 to the one or more nodes as a response to the database query. In various embodiments, the method further includes applying one or more UDTFs on the plurality of responses to generate the table with records. In various embodiments, the method includes running a transformation on a basic hardcoded seed table with 1 column and 1 row and transforming that row into a fully populated table having the predetermined number of columns with data from the API. In various embodiments, the method includes transforming the graph structure into the tabular structure.

In an exemplary embodiment, a ZIO toolset is used and ZIO based library of services are developed to make API calls in parallel that is used in the UDTFs. In various embodiments, the method involves updating the table to expose more information in the BI tools by extending the existing UDTF capability to add columns. This is done by a module that allows for the definition of the columns that are automatically translated into the actual Spark SQL columns with the data retrieval. The different types of columns are grouped and the data retrieval logic is reused in the columns. This speeds up the process of populating the table by getting the number of pages of the data at the same time and merging the data.

In various embodiments, a non-transitory computer-readable medium that has stored, computer-executable instructions which, when executed by a computer in a system, cause the computer to execute operations is disclosed. In various embodiments, the codes when executed include receiving a database query from a BI software application executable on one or more nodes. The database query is a SQL query or Spark SQL and may correspond to a request to access data from a data source. In various embodiments, the database query is processed using the Web API (such as a GraphQL® API) or an HTTP API or both. The received database query is processed to generate a plurality of queries (such as HTTP GraphQL® requests) to retrieve data from the backend. A plurality of Cypher requests are sent to the data source to retrieve data. Parallelism is performed via a ZIO toolset and ZIO based library of services. In various embodiments, authentication credentials from the software application are received. A plurality of authentication tokens are generated based on the received authentication credentials and each authentication token of the generated plurality of authentication tokens is passed on to the corresponding worker thread of the plurality of worker threads which then verify the authentication credentials with credentials of the GraphQL® API.

In various aspects, a plurality of responses containing data is received from the one or more backends, in response to the plurality of HTTP requests. In various embodiments, the plurality of responses are processed to generate a table that is defined by a relational database schema and the generated table is transmitted to the one or more nodes as a response to the database query. In various embodiments, the code further includes applying one or more UDTFs on the plurality of responses to generate the table with records.

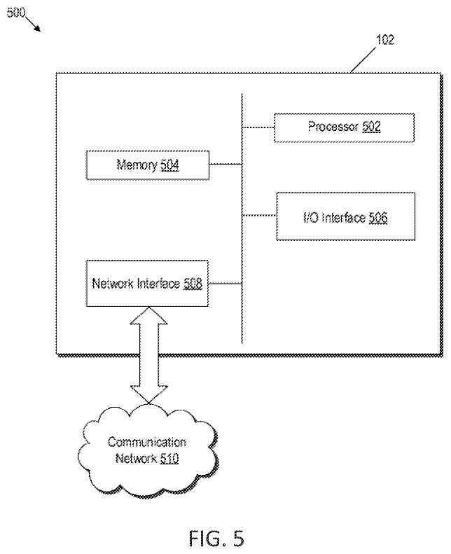

FIG. 5 is a diagram that illustrates a block diagram of the system of FIG. 1, in accordance with an embodiment of the disclosure. With reference to FIG. 5, there is shown the system 500. The system 500 includes the system 102 that is connected to a communication network 510. The system 102 includes a processor 502, a memory 504, I/O interface 506 and a network interface 508 to connect to the communication network 510. The BI Tools such as Tableau® and Power BLD connect to Hive/Spark SQL® with queries to get data from the data source over the communication network 510. The data source is not limited to ONgDB, the BI tools may request data from any database. The Hive/Spark SQL then hits the backend that serves GraphQL® API in the system 102. The backend also receives the authentication credentials from the BI tool. A plurality of authentication tokens is generated based on the received authentication credentials. The authentication tokens are passed on to the corresponding worker thread which then verifies the authentication credentials with credentials of the GraphQL® API. A plurality of HTTP requests are delivered to the backend to retrieve data. For each request received in the backend, Cypher requests are concurrently sent to the data source. Each query is assigned to a corresponding worker thread and a number of responses containing data are received from the backends. A table that is defined by a relational database schema is generated and transmitted to the BI tools. The table that is generated is based on a UDTFs and the table is populated with data from the API.

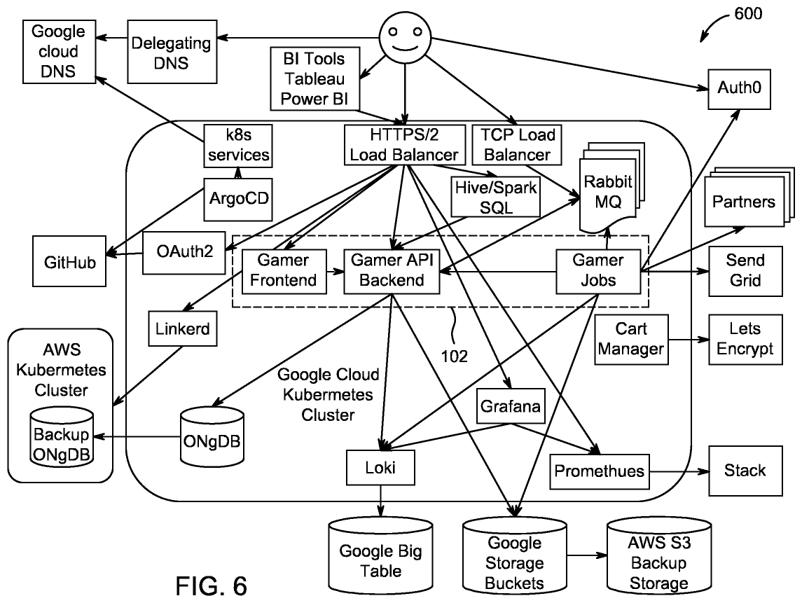

FIG. 6 is a diagram that demonstrates the incorporation of the system and the method in big data tools. With reference to FIG. 6, there is shown a BI system 600 that incorporate the system 102 that includes the Garner frontend, GarnerAPl backend and Garner Jobs. The BI system 600 as shown in FIG. 6 includes the BI tools, load balancer, Hive/Spark API, the system 102 having the Gamer frontend, GarnerAPl backend and Garner Jobs, and ONgDB Database. The BI tools connect to the load balancer which is a gateway or a firewall. The load balancer connects to the Hive/Spark API that connects to GarnerAPl backend. The GarnerAPl backend connects to ONgDB Database, from which enormous amount of data has to be retrieved. Gamer API backend is stateless and auto-scales out 100× or even 1000× if needed to support parallel query load. The BI Tools send SQL requests using Hive protocol to Hive/Spark SQL server. The Spark API takes a SQL request and converts it to a plurality of Garner API Backend HTTP GraphQL requests to retrieve the data. These are parallel requests. So, for a single SQL request, a plurality of HTTP requests are sent to retrieve the data from the Garner API Backend. The Garner API Backend includes a plurality of backends running at the same time processing the HTTP requests simultaneously. For each GraphQL request to each of the Garner API Backends, Cypher request is sent to ONgDB to get the data and filter it according to visibility/auth rules. Thereafter, data that is received in response from the backend as GraphQL responses is processed using UDTFs and served as a single table to node(s) that include the BI Tools.

The advantages of the disclosed subject matter include supporting distributed retrieval and parallelism via Spark Workers and a custom authentication mechanism for OAuth2 based on built-in Spark SQL username and password authentication built into the protocol. Also, GraphQL® response is represented as a table that may be retrieved and described via SQL describe command that allows for automatic schema derivation in business analytics tools. Further, the system is capable of storing an enormous amount of data

Although the detailed description contains many specifics, these should not be construed as limiting the scope of the invention but merely as illustrating different examples and aspects of the invention. It should be appreciated that the scope of the invention includes other embodiments not discussed herein. Various other modifications, changes and variations which will be apparent to those skilled in the art may be made in the arrangement, operation and details of the system and method of the present invention disclosed herein without departing from the spirit and scope of the invention as described here.

What is claimed is:

1. A system, comprising:
a processor configured to:
receive, from a software application executable on one or more nodes, a database query that corresponds to a request to access relational data from a data source;
process the received database query to generate a plurality of queries, each of which includes data with a syntax that is in accordance with a query language different from that of the database query;
deliver the pluralities of queries as HTTP requests concurrently to one or more application programming interface (API) backends to retrieve data;
deliver, for each request to each of the API backend, a corresponding cypher request to the data source;
receive, from the one or more backends, a plurality of responses in a response to a delivery of the plurality of HTTP requests,
wherein each response of the received plurality of responses includes a portion of data of the data source in a format that is different from a schema of the data source;
generate, based on the plurality of responses from the backends, a table that is defined by one or more user-defined table functions (UDTFs); and
transmit the generated table to the one or more nodes as a response to the database query.

2. The system according to claim 1, wherein the software application is a Business Intelligence (BI) application.

3. The system according to claim 1, wherein the database query is a Structured Query Language (SQL) query or Spark SQL and the query language of each of the plurality of queries is a GraphQL® query language.

4. The system according to claim 1, wherein the database query is processed using a GraphQL® API, an HTTP API, or a combination of GraphQL® API and HTTP API.

5. The system according to claim 1, wherein the processor is further configured to assign each query of the plurality of queries to a corresponding worker thread of a plurality of worker threads on the system, and
wherein the plurality of HTTP requests are delivered concurrently based on the assignment.

6. The system according to claim 5, wherein the processor is further configured to:
receive authentication credentials from the software application;
generate a plurality of authentication tokens based on the received authentication credentials; and
pass each authentication token of the generated plurality of authentication tokens to the corresponding worker thread of the plurality of worker threads.

7. The system according to claim 6, wherein the plurality of worker threads use the plurality of authentication tokens, each token comprising an Open Authorization (OAuth) token to verify the authentication credentials with credentials of the GraphQL® API, and
wherein the verification is performed before the delivery of the plurality of HTTP requests.

8. The system according to claim 1, wherein the format corresponds to a non-relational database schema and is one of: a JavaScript Object Notation (JSON), eXtended Markup Language (XML), or YAML.

9. The system according to claim 1, wherein the processor is further configured to apply the UDTFs on the plurality of responses to generate the table with records.

10. The system according to claim 1, wherein the processor is configured to derive the relational database schema for the generated table, based on the plurality of responses.

11. The system according to claim 1, wherein each response of the plurality of responses includes the portion of data with pagination.

12. A method of abstracting GraphQL API as a Spark SQL interface, comprising:
in a system:
receiving, from a software application executable on one or more nodes, a database query that corresponds to a request to access relational data from a data source;
processing the received database query to generate a plurality of queries, each of which includes data with a syntax that is in accordance with a query language different from that of the database query;
processing the plurality of queries to pass a plurality of concurrent HTTP requests to one or more API backends to retrieve data;
delivering, for each request to each of the API backend, a corresponding cypher request to the data source;
receiving, from the one or more backends, a plurality of responses in response to the plurality of HTTP requests,
wherein each response of the received plurality of responses includes a portion of data of the data source in a format that is different from a schema of the data source;
processing the plurality of responses from the one or more backends to generate a table that is defined by one or more user-defined table functions (UDTFs); and
transmitting the generated table to the one or more nodes as a response to the database query.

13. The method according to claim 12, wherein the database query is a Structured Query Language (SQL) or Spark SQL and the query language of each of the plurality of queries is a GraphQL® query language.

14. The method according to claim 12, wherein processing the database query comprises using a GraphQL® API or an HTTP API or a combination of GraphQL® API and HTTP API.

15. The method according to claim 12, further comprising assigning each query of the plurality of queries to a corresponding worker thread of a plurality of worker threads on the system,
wherein the plurality of HTTP requests are delivered concurrently based on the assignment.

16. The method according to claim 15, further comprising:
receiving authentication credentials from the software application;
generating a plurality of authentication tokens based on the received authentication credentials; and
passing each authentication token of the generated plurality of authentication tokens to the corresponding worker thread of the plurality of worker threads.

17. The method according to claim 16, wherein the plurality of worker threads use the plurality of authentication tokens to verify the authentication credentials with credentials of the GraphQL® API, and
wherein the verification is performed before the delivery of the plurality of HTTP requests.

18. The method according to claim 12, further comprising applying one or more UDTFs on the plurality of responses to generate the table with records.

19. The method according to claim 12, further comprising deriving the relational database schema for the generated table, based on the plurality of responses.

20. A non-transitory computer-readable medium having stored thereon, computer-executable instructions which, when executed by a computer in a system, cause the computer to execute operations, the operations comprising:
receiving, from a software application executable on one or more nodes, a database query that corresponds to a request to access relational data from a data source;
processing the received database query to generate a plurality of queries, each of which includes data with a syntax that is in accordance with a query language different from that of the database query;
processing the plurality of queries to pass a plurality of concurrent HTTP requests to one or more API backends to retrieve data;
delivering, for each request to each of the API backend, cypher request to the data source;
receiving, from the one or more backends, a plurality of responses in response to the plurality of HTTP requests,
wherein each response of the received plurality of responses includes a portion of data of the data source in a format that is different from a schema of the data source;
processing the plurality of responses to generate a table that is defined by one or more user-defined table functions (UDTFs); and
transmitting the generated table to the one or more nodes as a response to the database query.
